(19) United States
(12) Patent Application Publication
(10) Pub. No.: US 2020/0156055 A1
(43) Pub. Date: May 21, 2020

(54) ODH CATALYST REGENERATION AND INTEGRATION WITH AN AIR SEPARATION UNIT

(71) Applicant: NOVA Chemicals (International) S.A., Fribourg (CH)

(72) Inventors: Shahin Goodarznia, Calgary (CA); Vasily Simanzhenkov, Calgary (CA); Kamal Serhal, Calgary (CA)

(73) Assignee: NOVA Chemicals (International) S.A., Fribourg (CH)

(21) Appl. No.: 16/690,372

(22) Filed: Nov. 21, 2019

(30) Foreign Application Priority Data
Nov. 21, 2018 (CA) 3024612

(51) Int. Cl. B01J 38/12; B01J 23/96; B01J 23/652

(52) U.S. Cl. CPC B01J 38/12; B01J 23/6525; B01J 23/96

(57) ABSTRACT

Oxidative dehydrogenation of alkanes employs a catalyst, usually a mixed metal oxide, to convert, in the presence of oxygen, a lower alkane into its corresponding alkene. Continuous operation of an oxidative dehydrogenation process may result in a gradual decrease of catalyst activity and or selection, requiring downtime for regeneration. Provided herein is a process for regeneration of an oxidative dehydrogenation catalyst including initiating regeneration by passing a regeneration gas over the catalyst, monitoring regeneration by comparing the oxygen concentration of the regeneration gas before and after being passed over the catalyst, and ceasing regeneration when the oxygen concentration of the regeneration gas after passed over the catalyst is at least 90% of the concentration of the regeneration gas before being passed over the catalyst.

### CROSS REFERENCE TO RELATED APPLICATIONS

This application claims the benefit of the earlier filing date of Canadian application serial number 3,024,612 filed on Nov. 21, 2018. The contents of Canadian application serial number 3,024,612 are incorporated herein by reference in their entirety.

### TECHNICAL FIELD

The present disclosure relates generally to oxidative dehydrogenation (ODH) of lower alkanes into corresponding alkenes. More specifically, the present disclosure relates to a process for the regeneration of an ODH catalyst.

### BACKGROUND

Catalytic oxidative dehydrogenation (ODH) of alkanes into corresponding alkenes is an alternative to steam cracking; steam cracking is the method of choice for the majority of today's commercial-scale producers. Despite its widespread use, steam cracking has its downsides. Steam cracking is energy intensive, requiring temperatures in the range of 700° C. to 1000° C. to satisfy the highly endothermic nature of the cracking reactions. This also results in significant amounts of greenhouse gasses. The process is expensive owing to the high fuel demand, the requirement for reactor materials that can withstand the high temperatures, and the necessity for separation of unwanted by-products using downstream separation units. The production of coke by-product requires periodic shutdown for cleaning and maintenance. For ethylene producers, the selectivity for ethylene is only around 80-85% for a conversion rate that does not generally exceed 60%. In contrast, oxidative dehydrogenation operates at lower temperatures, produces insignificant amounts of greenhouse gasses, does not produce coke, and using newer-developed catalysts provides selectivity for ethylene that can reach 98% at conversion rates of 60% or more. The advantages of oxidative dehydrogenation are, however, overshadowed by the requirement for the potentially catastrophic mixing of oxygen with a hydrocarbon within a confined space.

### SUMMARY

In one aspect, a process for regenerating an oxidative dehydrogenation catalyst is provided. More specifically, the process includes initiating regeneration by passing a regeneration gas including O₂ over the oxidative dehydrogenation catalyst at an initiation temperature; monitoring regeneration by measuring the O₂ concentration of an effluent gas including regeneration gas that has been passed over the oxidative dehydrogenation catalyst; maintaining regeneration by continuing to pass the regeneration gas over the oxidative dehydrogenation catalyst until the O₂ concentration of the effluent gas is at least 90% of the O₂ concentration of the regeneration gas; and ceasing regeneration by stopping passing of the regeneration gas over the oxidative dehydrogenation catalyst. Further, the regeneration gas includes from 0.5 vol % to 10 vol % O₂ when the initiation temperature is greater than or equal to 250° C., or from 0.5 to 21 vol % O₂ when the initiation temperature is below 250° C.

The process disclosed herein promotes safe regeneration of an oxidative dehydrogenation catalyst either by lowering the concentration of oxygen in the regeneration gas or by lowering the initiation temperature and includes monitoring regeneration to encourage optimal regeneration duration so as to avoid excessive downtime or prevent premature employment of an insufficiently regenerated catalyst. The process may be combined with a purge step for removing reactive species from the catalyst prior to regeneration or with monitoring of carbon dioxide production as a proxy for assessing hydrocarbon levels on or in close proximity to the oxidative dehydrogenation catalyst.

It is understood that the disclosure described in this specification is not limited to the examples summarized in this Summary. Various other aspects are described and exemplified herein.

### BRIEF DESCRIPTION OF THE DRAWINGS

There are no drawings.

### DETAILED DESCRIPTION

The exemplifications set out herein illustrate certain examples, in one form, and such exemplifications are not to be construed as limiting the scope of the examples in any manner.

Certain exemplary aspects of the present disclosure will now be described to provide an overall understanding of the principles of the process disclosed herein. Those of ordinary skill in the art will understand that the processes described herein are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the properties that the present disclosure desires to obtain. At the very least, and not as an attempt to limit the application of the doctrine of equivalents to the scope of the claims, each numerical parameter should at least be construed in light of the number of reported significant digits and by applying ordinary rounding techniques.

Embodiments of the present techniques are directed to regenerating an oxidative dehydrogenation catalyst which can react alkanes to alkenes, such as ethane to ethylene. Typically, for oxidative dehydrogenation, a gas stream including the alkane and oxygen is contacted with an oxidative dehydrogenation catalyst resulting in a product stream including the alkene, unreacted alkane, water and various other potential by-products. For example, ethane oxidative dehydrogenation results in a product stream including ethylene, unreacted ethane, carbon dioxide, carbon monoxide, water, and possibly one or more of acetic acid, acetaldehyde, and ethanol. Contact between the gas stream and the oxidative dehydrogenation catalyst occurs as the gas stream is passed over the oxidative dehydrogenation catalyst.

As used herein, the term “passed over” refers to any manner in which a gaseous composition contacts an oxidative dehydrogenation catalyst, particularly with respect to regeneration gases used in conjunction with the disclosure. In various examples, “passed over” includes situations where the gaseous composition flows past an immobilized or fluidized oxidative dehydrogenation catalyst, such as in a fixed bed reactor or fluidized bed reactor, respectively, and wherein the contact time is short and depends on the flow rate of the gaseous composition. In other examples, “passed over” refers to scenarios where an oxidative dehydrogenation catalyst is incubated with a gaseous composition for extended periods, contact between the oxidative dehydrogenation catalyst and the gaseous composition ceasing when the gaseous composition is removed.

As used herein, the term “regeneration gas” refers to a gaseous composition, including oxygen, before contact with an oxidative dehydrogenation catalyst. Examples include, but are not limited to, dilute air, where the concentration of oxygen is between 0.5 vol % and 10 vol %, pure air, and pure oxygen.

As used herein, the term “effluent gas” refers to gaseous compositions that have been passed over an oxidative dehydrogenation catalyst. That is, effluent gas represents gaseous compositions that have been in contact with and have ceased contact with an oxidative dehydrogenation catalyst.

As used herein, the term “oxidative dehydrogenation catalyst” refers to catalysts used in the oxidative dehydrogenation of an alkane into its corresponding alkene. The most frequently described oxidative dehydrogenation catalysts are mixed metal oxide catalysts. Use of the term “catalyst”, unless otherwise indicated, is synonymous with oxidative dehydrogenation catalyst. Furthermore, referral to an oxidative dehydrogenation catalyst can include a mixture of more than one oxidative dehydrogenation catalyst, each having different chemical compositions.

As used herein, the term “catalyst bed” refers to the entirety of the space occupied by the catalyst, including the empty spaces between catalyst particles. A catalyst bed may have a beginning and an end, such as in a fixed bed where gaseous compositions move from the beginning to the end of the bed, in an arrangement that would be well understood by the person of ordinary skill in the art. For fixed bed reactors the catalyst bed would not include sections devoid of catalyst particles including packing material that precedes or follows the bed. In a fluidized bed reactor, the catalyst bed would refer to the entire volume of catalyst that moves around in a fluidized manner due to the influx of a gaseous composition through a distributor or support plate, with the bed beginning at the top side of the distributor plate and ending at the upper limit of fluidization, usually near the top of the reactor where gaseous compositions are removed.

As used herein, the term “temperature runaway event” refers to loss of temperature control of the catalyst bed as the temperature increases due to the exothermic nature of oxidation of the metals present in the catalyst and, if occurring, oxidation of residual hydrocarbons present on the surface of or in close proximity to the catalyst. Mechanisms for removing heat from oxidation reactors are well known, and include, but are not limited to, increasing the flow rate of feed gases and manipulating the ability of cooling media to remove heat during steady state operations. Loss of temperature control means the heat generated by the oxidation reactions exceeds the maximum capacity for heat removal from all the employed and available mechanisms combined. For the present disclosure, temperature runaway events are undesirable because there is risk of reaching a temperature where the catalyst is irreversibly destroyed or inactivated.

As used herein, the term “initiation temperature” refers to the temperature of the catalyst bed. It is well known that catalyst beds may have a temperature profile or gradient that can vary according to reactor type, process conditions and catalyst composition. Measuring or estimating the temperature of the catalyst bed is also well known in the art, including measuring the temperature at single or multiple points within the catalyst bed. The initiation temperature can be the maximum temperature within the catalyst bed, but when the variation of temperature within the catalyst bed is minimal, ranging no more than 25° C., such as no more than 10° C., the initiation temperature may be an average of the temperature within the catalyst bed.

As used herein, the term “saturation level” when referring to the catalyst refers to the fraction of the metals within the catalyst that are at their highest oxidation state. A maximum saturation level of the catalyst, for example, refers to a catalyst where the level of oxygen on the catalyst surface is in equilibrium with regeneration gas. As a catalyst approaches the highest saturation level the risk of a temperature runaway event is significantly reduced, owing to the fact the opportunity for an oxidation reaction with a metal of the catalyst is minimal A completely saturated catalyst would not be susceptible to a temperature runaway event due to the oxidation state of metals in the catalyst.

Continuous operation of an oxidative dehydrogenation reactor that includes an oxidative dehydrogenation catalyst is likely to lead to deactivation of the oxidative dehydrogenation catalyst over time. Regeneration of the oxidative dehydrogenation catalyst under these circumstances would be required and the reactor would need to be taken offline, effecting the commercial viability. Regeneration of an oxidative dehydrogenation catalyst may be achieved by oxidation of the oxidative dehydrogenation catalyst whereby a regeneration gas including and oxidant, usually air, is passed over the oxidative dehydrogenation catalyst. A person skilled in the art would appreciate that passing air over an oxidative dehydrogenation catalyst where hydrocarbons may be present poses a safety risk at higher temperatures. A commercially viable oxidative dehydrogenation reactor would be expected to operate at temperatures over 300° C., resulting in a need to cool the reactor down during regeneration. This impacts the duration of time in which the reactor would be offline.

The present disclosure, in one aspect, seeks to limit the degree to which the reactor needs to be cooled down by using dilute air, with a lower oxygen concentration, so that the risk of a flammable event is minimized. By using dilute air as the regeneration gas, where the O₂ concentration is below 10 vol %, regeneration can be initiated at initiation temperatures over 250° C. A person skilled in the art would understand that while higher initiation temperatures can be used to shorten the regeneration time, the regeneration initiation temperature can be kept below 380° C., such as below 340° C. Striking a balance between reasonable regeneration time and minimizing the risk of a temperature runaway event is ideally accomplished by using a regeneration initiation temperature of between 300° C. and 340° C., in combination with a regeneration gas where the concentration of oxygen is no more than 10 vol %, such as no more than 8 vol %. The temperature of the regeneration gas prior to contact with the oxidative dehydrogenation catalyst should ideally be at or close to the initiation temperature to reduce any effect on the temperature on the catalyst. Heating or cooling the regeneration gas prior to being passed over the catalyst can be achieved using any means known in the art.

When dilute air is not available, regeneration with pure air as the regeneration gas may be initiated at initiation temperatures below 250° C., such as below 200° C.

Depending upon the catalyst, temperatures of 250° C. may be too high when using regeneration gas that has an O₂ concentration higher than 10 vol %. Continually monitoring of the temperature of the catalyst bed is recommended should a temperature runaway event occur. It is known that regeneration of a catalyst takes longer at lower temperatures. For the present disclosure, at initiation temperatures below 200° C., when using pure air as a regeneration gas, the regeneration initiation temperature can be at least 140° C. When using pure air, where the O₂ concentrating is about 21 vol %, a regeneration initiation temperature of between 140° C. and 170° C. provides for regeneration in a reasonable time while minimizing the risk of temperature runaway event. A person skilled in the art can appreciate that temperatures below 250° C. are not easily attained with fixed bed reactors that use molten salt as a cooling media, or that reactors may take considerable time to cool to temperatures as low as 250° C., and that regeneration of an oxidative dehydrogenation catalyst in a fixed bed at these temperatures, while theoretically possible, may require removal of the catalyst to another vessel or allow sufficient time to provide for natural cooling to the desired temperature. Fluidized bed reactors permit better control at lower temperatures and are more suited to low temperature regeneration.

The initiation temperature represents the temperature of the catalyst bed when passing the regeneration gas over the catalyst bed begins. In the absence of temperature control by an operator the temperature would be expected to rise after initiation due to the oxidation reactions occurring with respect to the catalyst. During regeneration, an operator may choose to maintain the temperature of the catalyst bed at or in close proximity to the initiation temperature, or alternatively, an operator may increase the temperature as regeneration progresses, which would allow for quicker regeneration. Increasing the temperature may be accomplished in steps, or may be ramped, and ideally will not exceed a temperature that effects the integrity of the catalyst or the reactor design specification. Increasing the temperature of the catalyst bed can be achieved using any known means in the art. However, should a temperature runaway event occur in that attempts to control the temperature are ineffective and the temperature continues to rise, then passing the regeneration gas over the catalyst should be ceased or the O₂ concentration in the regeneration gas should be lowered. Switching to an inert gas may also be recommended in these circumstances.

Theoretically, pure oxygen could be used for regeneration, but would require careful monitoring of conditions, including continual monitoring of the temperature of the catalyst bed and the level of residual hydrocarbons present on or in close proximity to the catalyst. Using pure oxygen during the initial stages of regeneration is associated with a higher risk of a flammable event or a temperature runaway event.

Optimizing regeneration time can be essential to minimize the financial impacts of a shutdown. Regeneration times that are too long, such as in situations where regeneration is continuing even though the catalyst has been regenerated, result in loss of valuable production time. Conversely, regeneration times that are too short result in operation of the oxidative dehydrogenation reactor when the catalyst is not at optimal performance and reaches deactivation, and the required regeneration downtime, sooner. The present disclosure, in another aspect, involves monitoring the regeneration process to allow for optimal regeneration times, minimizing costly delays during downtime.

Oxidation of an oxidative dehydrogenation catalyst during regeneration results in consumption of oxygen by the catalyst. When regeneration of the catalyst is initiated the degree to which oxygen can be consumed is higher. As regeneration progresses and the catalyst undergoes oxidation the rate at which oxygen is consumed by the catalyst is reduced. The difference in the oxygen levels in the regeneration gas and the effluent gas provides an indication to what degree the catalyst has been oxidized. For the present disclosure, the catalyst is considered to be sufficiently regenerated when the concentration of oxygen (in vol %) in the effluent gas is at least 90% of the oxygen concentration (in vol %) of the regeneration gas before being passed over the catalyst. Maintaining a flow of regeneration gas over the catalyst while the concentration of oxygen in the effluent gas is less than 90% of the concentration of oxygen in the regeneration gas avoids scenarios where regeneration is halted prematurely, and an incompletely regenerated catalyst is used during operation of the oxidative dehydrogenation reactor. Once the concentration of oxygen in the effluent passes the 90% threshold an operator can be confident that the catalyst will provide acceptable conversion levels. A person skilled in the art would appreciate that a higher percentage of oxygen in the effluent gas relative to the regeneration gas, such as 92% or 95%, may provide an even more active catalyst.

Oxidation of the catalyst with the regeneration gas may be accompanied by oxidation of hydrocarbons present in (in the form of chemisorption or physisorption) or in close proximity to the catalyst surface, possibly resulting in the production of carbon dioxide, CO₂. It is contemplated in the present disclosure to monitor, in addition to O₂ levels, CO₂ levels in the effluent gas. After initiation of regeneration it is possible that an increase in CO₂ concentration in the effluent gas relative to the regeneration gas may be seen. In this instance oxidation of hydrocarbons in the catalyst is likely occurring. As regeneration progresses the amount of hydrocarbon present in or on the catalyst should decrease, resulting in lower production of CO₂. At some point it is expected that the concentration of CO₂ in the effluent gas should approximate the concentration of CO₂ in the regeneration gas, an indication that there is limited oxidation of carbon in the catalyst occurring. If oxygen levels in the effluent gas are still relatively low compared to the regeneration gas but CO₂ levels are stable then an operator would expect that regeneration should proceed as oxygen is still being consumed in the oxidation of the metals present in the catalyst, and the drop in oxygen in the effluent gas is not due to oxidation of carbon in the catalyst. Conversely, if the concentration of oxygen in the effluent gas is approaching 90% of the concentration of oxygen in the regeneration gas, yet the CO₂ concentration in the effluent gas is still higher than the regeneration gas it would indicate that any further increase of O₂ concentration in the effluent gas may be due more as a result of a decrease in the oxidation of hydrocarbons in the catalyst as opposed to a decrease in the oxidation rate of the catalyst itself. In some embodiments, the concentration of CO₂ in the effluent gas is less than 110% of the concentration of CO₂ in the regeneration gas.

The presence of hydrocarbons in or in close proximity to the catalyst surface increases the risk of an uncontrolled flammable event. This is particularly true when using higher concentrations of oxygen for regeneration. Removal of hydrocarbons prior to regeneration would provide an extra layer of safety. In some embodiments, the catalyst is purged of hydrocarbons by passing an inert gas over the catalyst until the hydrocarbon levels in the inert effluent gas are below 2.5 vol %, such as below 1.0 vol %, or below 0.5 vol %, the inert effluent gas including the inert gas after it has been passed over the catalyst. The inert gas must be non-reactive with the catalyst and any components that are in or associated with the catalyst at the conditions the inert gas is passed over the catalyst. In some embodiments, the inert gas includes no more than 0.5 vol % O₂. In some embodiments, the inert gas is nitrogen.

Air separation technology is well known and is used to separate air into nitrogen and oxygen. Use of air separation technology in the context of oxidative dehydrogenation is contemplated, as the separated oxygen can be used as an oxygen source for the oxidative dehydrogenation reaction. In this context, where the objective is to produce a relatively pure oxygen source, the separated nitrogen would be designated as a nitrogen waste stream. Separated nitrogen, however, in some instances would also be useful, such as for the devolatilization of low-density polyethylene to remove volatile organic compounds. However, for the purposes of this disclosure separated nitrogen will be designated as a nitrogen waste stream. Use of air separation technology for oxidative dehydrogenation for the present disclosure would be helpful in that the nitrogen waste stream could be used as the inert gas in the purging of the oxidative dehydrogenation catalyst.

For maximum benefit, the present disclosure is best employed when the oxidative dehydrogenation catalyst is situated within an oxidative dehydrogenation reactor. In this instance, the regeneration can be completed without relocating the catalyst, resulting in downtimes of shorter duration. However, use of the present disclosure is contemplated for all known reactor configurations, including multiple reactors, in series or parallel configuration, fixed bed reactors, fluidized bed reactors, and swing bed type reactors. In each configuration the oxidative dehydrogenation catalyst may be regenerated using the present disclosure. Combinations of reactor type are also contemplated. For example, oxidative dehydrogenation catalysts can be situated in a fluidized bed reactor, such as (1) a non-circulating fluidized bed, (2) a circulating fluidized bed with regenerator, or (3) a circulating fluidized bed without regenerator.

It is contemplated with the present disclosure that the oxidative dehydrogenation catalyst is moved to a regeneration bed before regeneration. In this instance, the oxidative dehydrogenation catalyst is removed from an oxidative dehydrogenation reactor to the regeneration bed and replaced with a separate oxidative dehydrogenation catalyst in the oxidative dehydrogenation reactor. This would allow regeneration of the first oxidative dehydrogenation catalyst to proceed without shutting down the oxidative dehydrogenation reactor. The two or more catalysts can be of a different or the same composition. It is also contemplated that multiple regeneration beds are employed, which would allow a user to ensure that an active catalyst is at all times ready for use.

In some embodiments, the oxidative dehydrogenation catalyst in a second reactor may be the same catalyst type as the oxidative dehydrogenation catalyst in a first reactor. In some embodiments, the catalyst is a low temperature catalyst that includes molybdenum, vanadium, tellurium, niobium, and oxygen wherein the molar ratio of molybdenum to vanadium is from 1:0.12 to 1:0.49, the molar ratio of molybdenum to tellurium is from 1:0.01 to 1:0.30, the molar ratio of molybdenum to niobium is from 1:0.01 to 1:0.30, and oxygen is present at least in an amount to satisfy the valency of any present metal oxides. The molar ratios of molybdenum, vanadium, tellurium, niobium can be determined by inductively coupled plasma mass spectrometry (ICP-MS). The catalyst may be a low temperature catalyst which provides for an oxidative dehydrogenation reaction at less than 450° C., less than 425° C., or less than 400° C.

In an embodiment, the oxidative dehydrogenation catalyst is a mixed metal oxide having the formula MoₐV_{b}Te_{c}Nb_{d}PdₑO_{f}, wherein a, b, c, d, e, and f subscripts are relative atomic amounts of the elements Mo, V, Te, Nb, Pd, O, respectively, and when a=1, then b=0.01 to 1.0, c=0.01 to 1.0, d=0.01 to 1.0, 0.00≤e≤0.10, and f is a number to satisfy the valence state of the catalyst.

In an embodiment, the oxidative dehydrogenation catalyst is a mixed metal oxide having the formula Ni_{g}AₕBᵢDⱼO_{f}, wherein g is a number from 0.1 to 0.9, such as from 0.3 to 0.9, or from 0.5 to 0.85, or from 0.6 to 0.8; h is a number from 0.04 to 0.9; i is a number from 0 to 0.5; j is a number from 0 to 0.5; and f is a number to satisfy the valence state of the catalyst; A is chosen from Ti, Ta, V, Nb, Hf, W, Y, Zn, Zr, Si and Al or mixtures thereof; B is chosen from La, Ce, Pr, Nd, Sm, Sb, Sn, Bi, Pb, Tl, In, Te, Cr, Mn, Mo, Fe, Co, Cu, Ru, Rh, Pd, Pt, Ag, Cd, Os, Ir, Au, Hg, and mixtures thereof; D chosen from Ca, K, Mg, Li, Na, Sr, Ba, Cs, and Rb and mixtures thereof; and O is oxygen.

In an embodiment, the oxidative dehydrogenation catalyst is a mixed metal oxide having the formula MoₐEₖGₗO_{f} wherein E is chosen from Ba, Ca, Cr, Mn, Nb, Ta, Ti, Te, V, W and mixtures thereof; G is chosen from Bi, Ce, Co, Cu, Fe, K, Mg, V, Ni, P, Pb, Sb, Si, Sn, Ti, U, and mixtures thereof; a=1; k is 0 to 2; 1=0 to 2, with the proviso that the total value of 1 for Co, Ni, Fe and mixtures thereof is less than 0.5; and f is a number to satisfy the valence state of the catalyst.

In an embodiment, the oxidative dehydrogenation catalyst is a mixed metal oxide having the formula VₘMoₙNbₒTeₚMe_{q}O_{f} wherein Me is a metal chosen from Ta, Ti, W, Hf, Zr, Sb and mixtures thereof; m is from 0.1 to 3; n is from 0.5 to 1.5; o is from 0.001 to 3; p is from 0.001 to 5; q is from 0 to 2; and f is a number to satisfy the valence state of the catalyst.

In an embodiment, the oxidative dehydrogenation catalyst is a mixed metal oxide having the formula Moₐ,VᵣXₛYₜZᵤMᵥO_{f} wherein X is at least one of Nb and Ta; Y is at least one of Sb and Ni; Z is at least one of Te, Ga, Pd, W, Bi and Al; M is at least one of Fe, Co, Cu, Cr, Ti, Ce, Zr, Mn, Pb, Mg, Sn, Pt, Si, La, K, Ag and In; a=1.0 (normalized); r=0.05 to 1.0; s=0.001 to 1.0; t=0.001 to 1.0; u=0.001 to 0.5; v=0.001 to 0.3; and f is a number to satisfy the valence state of the catalyst.

In an embodiment, of the oxidative dehydrogenation catalyst is a mixed metal oxide having the formula Mo₁V_{0.1-1}Nb_{0.1-1}Te_{0.01-0.02}X_{0-0.02}O_{f} wherein X is selected from Pd, Sb Ba, Al, W, Ga, Bi, Sn, Cu, Ti, Fe, Co, Ni, Cr, Zr, Ca and oxides and mixtures thereof, and f is a number to satisfy the valence state of the catalyst.

In operation, the oxidative dehydrogenation reactor receives a feed that may be one or more streams. The feed may include ethane, oxygen, diluent, and so forth. The diluent may be, for example, carbon dioxide or nitrogen. Other diluents are applicable.

In an embodiment, the regeneration gas is a gas in which the concentration of oxygen is between 0.5 vol % and 100 vol %. In an embodiment, the regeneration gas is a gas in which the concentration of oxygen is between 10 vol % and 100 vol %. In an embodiment, the regeneration gas is a gas in which the concentration of oxygen is between 21 vol % and 100 vol %. In an embodiment, the regeneration gas is a gas in which the concentration of oxygen is between 0.5 vol % and 21 vol %. In an embodiment, the regeneration gas is a gas in which the concentration of oxygen is between 0.5 vol % and 10 vol %. In an embodiment, the regeneration gas is a gas in which the concentration of oxygen is between 0.5 vol % and 8 vol %.

When the O₂ concentration of the effluent gas exceeds 90% of the O₂ concentration of the regeneration gas the oxidative dehydrogenation catalyst is ready for use and will provide near optimal conversion rates. In this state the oxidative dehydrogenation catalyst is closer to the maximum saturation level and the risk of a temperature runaway event is minimal. The present disclosure contemplates the prolongation of regeneration to increase the saturation level even further and as close to the maximum saturation level as possible, by increasing the O₂ concentration of the regeneration gas. This is particularly relevant when the regeneration gas includes dilute air. Prolongation regeneration gas represents regeneration gas used during a prolongation of regeneration. The O₂ concentration in the effluent gas will likely be below 90% of O₂ concentration in prolongation regeneration gas, the prolongation regeneration gas having a higher O₂ concentration than the regeneration gas. Passing prolongation regeneration gas over the catalyst should continue until the concentration of O₂ in the effluent gas reaches at least 90% of the O₂ concentration of the prolongation regeneration gas with the higher O₂ concentration.

The prolongation regeneration gas includes a concentration of O₂ that is higher than the O₂ gas of the regeneration gas used during initiating and maintaining regeneration. If the regeneration gas includes 10 vol % O₂ then the prolongation gas will require a concentration higher than 10 vol %, such as greater than 12 vol %. The prolongation regeneration gas can include O₂ concentrations ranging from 12 vol % to 21 vol %. The risk of a temperature runaway event after initial regeneration should be minimal, may allow that the prolongation regeneration gas include pure air, even when the temperature of the catalyst is over 300° C.

The present disclosure will be described by reference to the following examples. The following examples are merely illustrative of the disclosure and are not intended to be limiting.

### EXAMPLES

The present disclosure will be described by reference to the following examples. The following examples are merely illustrative of the disclosure and are not intended to be limiting.

A fixed bed reactor unit (FBRU) apparatus was used to conduct experiments using a mixed metal oxide oxidative dehydrogenation catalyst with the formula MoVNbTeO. The apparatus consisted of two fixed bed tubular reactors in series. Each reactor was wrapped in an electrical heating jacket and sealed with ceramic insulating material. Each reactor was a SS316L tube which had 1″ OD and 34″ length. Temperature control, particularly at lower temperatures, was limited and resulted in fluctuations. Temperatures listed in the examples represents averages of the temperatures at 4 different locations along the length of the catalyst bed, taking into account the fluctuations seen as a result of an inability to fine tune temperature.

In these experiments, ethane, ethylene carbon dioxide, oxygen and nitrogen were fed separately (on an as-needed basis) and premixed prior to the reactor inlet. Both reactors were controlled at the same reaction temperature. The catalyst bed consisted of one weight unit of catalyst to 2.33 units of weight of SS 316 particles, and the total weight of catalyst in each reactor was 150 g for example 1. The catalyst bed consisted of one weight unit of catalyst to 2.14 units of weight of Denstone 99 powder, and the total weight of catalyst in each reactor was 143 g for examples 2-5. The rest of the reactor bodies, below and above the catalyst bed, was packed with quartz powder and secured in place with glass wool on the top and the bottom of the reactor tube to avoid any movement during experimental runs.

The catalysts used in these examples were made in different batches, and were all of the formula: Mo₁V_{0.30}-0.49Te_{0.10-0.20}Nb_{0.10-0.20}O_{d}, based on ICP-MS and PIXE analyses.

The FBRU was also used to conduct regeneration of the used oxidative dehydrogenation catalyst. The catalyst was regenerated using various techniques. In each case, the oxidative dehydrogenation feed gas was switched to N₂ gas at a flow rate of 400 cm³/min prior to switching to regeneration gas. The results of the regeneration examples are presented in Table 1.

Regen #1 resulted in an unsuccessful regeneration process treatment due to multiple temperature runaway events. This is the result of using pure air as a regeneration gas and having an initiation temperature well above 250° C.

Regen #2 demonstrates successful regeneration at a lower initiation temperature of 161° C. The temperature within the catalyst bed was controlled and after some time, owing to the decreased risk of a temperature runaway event, was increased in steps to 310° C. Ethane conversion post regeneration was increased and selectivity to ethylene was unchanged.

Regen #3 demonstrates successful regeneration using dilute air with 2 vol % O₂ at an initiation temperature of 315° C., followed by a prolongation of regeneration using pure air (21 vol % O₂).

Regens #4 and #5 both demonstrate successful regeneration using dilute air (8 vol % O₂) at an initiation temperature of 319° C. The temperature of the catalyst bed was maintained at 315° C. for both examples. The regeneration time for Regen 4 was much shorter than the regeneration time for Regen 5 but still showed successful regeneration as the conversion rate increased without any significant change to ethylene selectivity.

The experimental conditions were chosen simply for demonstration of the effectiveness of the regeneration process described, and do not represent conditions that will likely be employed in a commercially viable setting. Commercial settings would be optimized so that conversion of ethane would exceed, at a minimum, 50%. The increase in conversion shown in the examples would likely be much higher under conditions that would be employed in a commercial setting. To see a change even at lower conversion levels demonstrates the positive effect of the regeneration process described herein.

TABLE 1
Oxidative Dehydrogenation Catalyst Regeneration Examples

| | Regen #1 | Regen #2 | Regen #3 | Regen #4 | Regen #5 |
|---|---|---|---|---|---|
| Initiation temperature (° C.) | 310 | 161 | 315 | 319 | 319 |
| Regeneration temperature (° C.) | n/a | 310 | 315 | 315 | 315 |
| Regeneration gas | Pure Air | Pure Air | 2 vol % O₂, | 8 vol % O₂ | 8 vol % O₂ |
| | | | 98 vol % N₂ | 92 vol % N₂ | 92 vol % N₂ |
| | | | (186 minutes | | |
| | | | @ 9677 | | |
| | | | cm³/min), | | |
| | | | followed by | | |
| | | | Pure Air | | |
| Regeneration gas flowrate (cm³/min) | 1000 | 1000 | 1000 | 3000 | 3000 |
| Treatment time (minutes) | Multiple | 1521 | 4004 | 1334 | 6855 |
| CO₂ in effluent ≤ 0.1 vol % | temperature | Yes | Yes | Yes | Yes |
| O₂ concentration in effluent ≥ 90% O₂ | runaway | Yes | Yes | Yes | Yes |
| concentration in regen feed gas | events | | | | |
| Pre regen ethane conversion (wt %) | | 18 | 21 | 15 | 17 |
| Post regen ethane conversion (wt %) | | 21 | 24 | 17 | 20 |
| Pre regen ethylene selectivity (wt %) | | 90 | 90 | 88 | 90 |
| Post regen ethylene selectivity (wt %) | | 90 | 91 | 90 | 90 |

### Additonal Embodiments

Embodiment 1 provides a process for regenerating an oxidative dehydrogenation catalyst, the process including initiating regeneration by passing a regeneration gas including O₂ over the oxidative dehydrogenation catalyst at an initiation temperature, monitoring regeneration by measuring the O₂ concentration of an effluent gas including regeneration gas that has been passed over the oxidative dehydrogenation catalyst, maintaining regeneration by continuing to pass the regeneration gas over the oxidative dehydrogenation catalyst until the O₂ concentration of the effluent gas is at least 90% of the O₂ concentration of the regeneration gas, and ceasing regeneration by stopping passing of the regeneration gas over the oxidative dehydrogenation catalyst and wherein the regeneration gas includes from 0.5 vol % to 10 vol % O₂ when the initiation temperature is greater than or equal to 250° C., or the regeneration gas includes from 0.5 to 21 vol % O₂ when the initiation temperature is below 250° C.

Embodiment 2 provides the process of embodiment 1, wherein monitoring regeneration further includes measuring the concentration of CO₂ in the effluent gas and wherein ceasing regeneration further includes stopping passing of the regeneration gas over the oxidative dehydrogenation catalyst when, in addition to when the oxygen concentration of O₂ in the effluent gas exceeding 90% of the concentration of O₂ in the regeneration gas, the concentration of CO₂ in the effluent gas is no more than 110% of the concentration of CO₂ in the regeneration gas.

Embodiment 3 provides the process of embodiments 1-2, wherein the oxidative dehydrogenation catalyst is purged of reactive species including hydrocarbons by passing an inert gas over the oxidative dehydrogenation oxidative catalyst before initiating regeneration.

Embodiment 4 provides the process of embodiment 3, wherein the inert gas includes nitrogen.

Embodiment 5 provides the process of embodiment 4, wherein the inert gas includes a nitrogen waste stream from an air separation unit.

Embodiment 6 provides the process of embodiment 3, wherein the inert gas is passed over the oxidative dehydrogenation catalyst until the concentration of hydrocarbons in an inert effluent gas including inert gas that has been passed over the oxidative dehydrogenation catalyst is no more than 2.5 vol %.

Embodiment 7 provides the process of embodiments 1-6, wherein the initiation temperature is from 300° C. to 340° C. and the concentration of O₂ in the regeneration gas is no more than 8 vol %.

Embodiment 8 provides the process of embodiment 7, further including prolonging regeneration before ceasing regeneration by passing a prolongation regeneration gas over the oxidative dehydrogenation catalyst until the O₂ concentration of the effluent gas is at least 90% of the O₂ concentration of the prolongation regeneration gas, wherein the prolongation regeneration gas includes the regeneration gas with a higher O₂ concentration.

Embodiment 9 provides the process of embodiment 8, wherein the regeneration gas includes 0.5 vol % to 8 vol % O₂ and the prolongation regeneration gas includes 10 vol % to 21 vol % 02.

Embodiment 10 provides the process of embodiments 1-9, wherein the oxidative dehydrogenation catalyst is an oxidative dehydrogenation reactor.

Embodiment 11 provides the process of embodiments 1-10, wherein the oxidative dehydrogenation catalyst is in a fixed bed reactor.

Embodiment 12 provides the process of embodiments 1-11, wherein the oxidative dehydrogenation catalyst is in a shell-and-tube type reactor.

Embodiment 13 provides the process of embodiments 1-10, wherein the oxidative dehydrogenation catalyst is in fluidized bed reactor.

Embodiment 14 provides the process of embodiments 1-13, the oxidative dehydrogenation catalyst is a mixed metal oxide.

Embodiment 15 provides the process of embodiments 1-14, wherein the oxidative dehydrogenation catalyst is selected from one or more of the group consisting of:

i) catalysts of the formula:

MoₐV_{b}Te_{c}Nb_{d}PdₑO_{f}

wherein a, b, c, d, e and f are the relative atomic amounts of the elements Mo, V, Te, Nb, Pd and O, respectively; and when a=1, b=0.01 to 1.0, c=0.01 to 1.0, d=0.01 to 1.0, 0.00≤e≤0.10 and f is a number to satisfy the valence state of the catalyst;

ii) catalysts of the formula:

Ni_{g}AₕBᵢDⱼO_{f}

wherein: g is a number from 0.1 to 0.9, such as from 0.3 to 0.9, or from 0.5 to 0.85, or from 0.6 to 0.8; h is a number from 0.04 to 0.9; i is a number from 0 to 0.5; j is a number from 0 to 0.5; and f is a number to satisfy the valence state of the catalyst; A is selected from the group consisting of Ti, Ta, V, Nb, Hf, W, Y, Zn, Zr, Si and Al or mixtures thereof; B is selected from the group consisting of La, Ce, Pr, Nd, Sm, Sb, Sn, Bi, Pb, Tl, In, Te, Cr, Mn, Mo, Fe, Co, Cu, Ru, Rh, Pd, Pt, Ag, Cd, Os, Ir, Au, Hg, and mixtures thereof; D is selected from the group consisting of Ca, K, Mg, Li, Na, Sr, Ba, Cs, and Rb and mixtures thereof; and O is oxygen;

iii) catalysts of the formula:

MoₐEₖGₗO_{f}

wherein: E is selected from the group consisting of Ba, Ca, Cr, Mn, Nb, Ta, Ti, Te, V, W and mixtures thereof; G is selected from the group consisting of Bi, Ce, Co, Cu, Fe, K, Mg, V, Ni, P, Pb, Sb, Si, Sn, Ti, U, and mixtures thereof; a=1; k is 0 to 2; 1=0 to 2, with the proviso that the total value of 1 for Co, Ni, Fe and mixtures thereof is less than 0.5; and f is a number to satisfy the valence state of the catalyst;

iv) catalysts of the formula:

VₘMoₙNbₒTeₚMe_{q}O_{f}

wherein: Me is a metal selected from the group consisting of Ta, Ti, W, Hf, Zr, Sb and mixtures thereof; m is from 0.1 to 3; n is from 0.5 to 1.5; o is from 0.001 to 3; p is from 0.001 to 5; q is from 0 to 2; and f is a number to satisfy the valence state of the catalyst; and

v) catalysts of the formula:

MoₐVᵣXₛYₜZᵤMᵥO_{f}

wherein: X is at least one of Nb and Ta; Y is at least one of Sb and Ni; Z is at least one of Te, Ga, Pd, W, Bi and Al; M is at least one of Fe, Co, Cu, Cr, Ti, Ce, Zr, Mn, Pb, Mg, Sn, Pt, Si, La, K, Ag and In; a=1.0 (normalized); r=0.05 to 1.0; s=0.001 to 1.0; t=0.001 to 1.0; u=0.001 to 0.5; v=0.001 to 0.3; and f is a number to satisfy the valence state of the catalyst.

Embodiment 16 provides the process of embodiments 1-14, wherein the oxidative dehydrogenation catalyst includes a mixed metal oxide of the formula:

Mo₁V_{0.1-1}Nb_{0.1-1}Te_{0.01-0.2}X_{0-0.2}O_{f}

wherein X is selected from Pd, Sb Ba, Al, W, Ga, Bi, Sn, Cu, Ti, Fe, Co, Ni, Cr, Zr, Ca and oxides and mixtures thereof, and f is a number to satisfy the valence state of the catalyst.

What is claimed is:

1. A process for regenerating an oxidative dehydrogenation catalyst comprising:
initiating regeneration by passing a regeneration gas comprising O₂ over the oxidative dehydrogenation catalyst at an initiation temperature;
monitoring regeneration by measuring the O₂ concentration of an effluent gas comprising the regeneration gas that has been passed over the oxidative dehydrogenation catalyst;
maintaining regeneration by continuing to pass the regeneration gas over the oxidative dehydrogenation catalyst until the O₂ concentration of the effluent gas is at least 90% of the O₂ concentration of the regeneration gas; and
ceasing regeneration by stopping passing of the regeneration gas over the oxidative dehydrogenation catalyst;
wherein the regeneration gas comprises from 0.5 vol % to 10 vol % O₂ when the initiation temperature is greater than or equal to 250° C. or from 0.5 to 21 vol % O₂ when the initiation temperature is below 250° C.

2. The process of claim 1, wherein monitoring regeneration further comprises measuring the CO₂ concentration of the effluent gas and wherein ceasing regeneration further comprises stopping passing of the regeneration gas over the oxidative dehydrogenation catalyst when the CO₂ concentration of the effluent gas is no more than 110% of the CO₂ concentration of the regeneration gas.

3. The process of claim 2, further comprising purging the oxidative dehydrogenation catalyst of hydrocarbons by passing an inert gas over the oxidative dehydrogenation catalyst before initiating regeneration.

4. The process of claim 3, wherein the inert gas comprises a nitrogen waste stream from an air separation unit.

5. The process of claim 3, wherein the inert gas is passed over the oxidative dehydrogenation catalyst until the concentration of hydrocarbons in an inert effluent gas comprising inert gas that has been passed over the oxidative dehydrogenation catalyst is no more than 2.5 vol %.

6. The process of claim 1, wherein the initiation temperature is from 140° C. to 170° C. and the regeneration gas comprises pure air.

7. The process of claim 5, wherein the initiation temperature is from 300° C. to 340° C. and the regeneration gas comprises an O₂ concentration of no more than 8 vol %.

8. The process of claim 1, wherein the oxidative dehydrogenation catalyst is in an oxidative dehydrogenation reactor.

9. The process of claim 8, wherein the oxidative dehydrogenation reactor is a fixed bed reactor.

10. The process of claim 8, wherein the oxidative dehydrogenation reactor is a fluidized bed reactor.

11. The process of claim 1, wherein the oxidative dehydrogenation catalyst is in a regeneration vessel.

12. The process of claim 7, further comprising prolonging regeneration before ceasing regeneration by passing a prolongation regeneration gas over the oxidative dehydrogenation catalyst until the O₂ concentration of the effluent gas is at least 90% of the O₂ concentration of the prolongation regeneration gas, wherein the prolongation regeneration gas comprises the regeneration gas with a higher O₂ concentration.

13. The process of claim 7, wherein once the O₂ concentration of the prolongation regeneration gas is between 8 vol % and 21 vol %.

14. The process of claim 1, wherein the oxidative dehydrogenation catalyst comprises a mixed metal oxide selected from the group consisting of:
i) catalysts of the formula:
MoₐV_{b}Te_{c}Nb_{d}PdₑO_{f}
herein a, b, c, d, e and f are the relative atomic amounts of the elements Mo, V, Te, Nb, Pd and O, respectively; and when a=1, b=0.01 to 1.0, c=0.01 to 1.0, d=0.01 to 1.0, 0.00≤e≤0.10 and f is a number to satisfy the valence state of the catalyst;
ii) catalysts of the formula:
Ni_{g}AₕBᵢDⱼO_{f}
wherein: g is a number from 0.1 to 0.9, such as from 0.3 to 0.9, or from 0.5 to 0.85, such as from 0.6 to 0.8; h is a number from 0.04 to 0.9; i is a number from 0 to 0.5; j is a number from 0 to 0.5; and f is a number to satisfy the valence state of the catalyst; A is selected from the group consisting of Ti, Ta, V, Nb, Hf, W, Y, Zn, Zr, Si and Al or mixtures thereof; B is selected from the group consisting of La, Ce, Pr, Nd, Sm, Sb, Sn, Bi, Pb, Tl, In, Te, Cr, Mn, Mo, Fe, Co, Cu, Ru, Rh, Pd, Pt, Ag, Cd, Os, Ir, Au, Hg, and mixtures thereof; D is selected from the group consisting of Ca, K, Mg, Li, Na, Sr, Ba, Cs, and Rb and mixtures thereof; and O is oxygen;
iii) catalysts of the formula:
MoₐEₖGₗO_{f}
wherein: E is selected from the group consisting of Ba, Ca, Cr, Mn, Nb, Ta, Ti, Te, V, W and mixtures thereof; G is selected from the group consisting of Bi, Ce, Co, Cu, Fe, K, Mg, V, Ni, P, Pb, Sb, Si, Sn, Ti, U, and mixtures thereof; a=1; k is 0 to 2; 1=0 to 2, with the proviso that the total value of 1 for Co, Ni, Fe and mixtures thereof is less than 0.5; and f is a number to satisfy the valence state of the catalyst;
iv) catalysts of the formula:
VₘMoₙNbₒTeₚMe_{q}O_{f}
wherein: Me is a metal selected from the group consisting of Ta, Ti, W, Hf, Zr, Sb and mixtures thereof; m is from 0.1 to 3; n is from 0.5 to 1.5; o is from 0.001 to 3; p is from 0.001 to 5; q is from 0 to 2; and f is a number to satisfy the valence state of the catalyst; and
v) catalysts of the formula:
MoₐVᵣXₛYₜZᵤMᵥO_{f}
wherein: X is at least one of Nb and Ta; Y is at least one of Sb and Ni; Z is at least one of Te, Ga, Pd, W, Bi and Al; M is at least one of Fe, Co, Cu, Cr, Ti, Ce, Zr, Mn, Pb, Mg, Sn, Pt, Si, La, K, Ag and In; a=1.0 (normalized); r=0.05 to 1.0; s=0.001 to 1.0; t=0.001 to 1.0; u=0.001 to 0.5; v=0.001 to 0.3; and f is a number to satisfy the valence state of the catalyst.

15. The process of claim 1, wherein the oxidative dehydrogenation catalyst comprises a mixed metal oxide of the formula:
Mo₁V_{0.1-1}Nb_{0.1-1}Te_{0.01-0.2}X_{0-0.20}f
wherein X is selected from Pd, Sb Ba, Al, W, Ga, Bi, Sn, Cu, Ti, Fe, Co, Ni, Cr, Zr, Ca and oxides and mixtures thereof, and f is a number to satisfy the valence state of the catalyst.
